(19) United States
(12) Patent Application Publication
(10) Pub. No.: US 2026/0154585 A1
(43) Pub. Date: Jun. 4, 2026

(54) STATE PREPARATION FOR QUANTUM ERROR CORRECTION

(71) Applicant: University of Florida Research Foundation, Incorporated, Gainesville, FL (US)

(72) Inventors: Prabhat MISHRA, Gainesville, FL (US); Daniel VOLYA, Gainesville, FL (US)

(21) Appl. No.: 18/953,468

(22) Filed: Nov. 20, 2024

Related U.S. Application Data
(60) Provisional application No. 63/609,493, filed on Dec. 13, 2023.

(51) Int. Cl. G06N 10/20; G06N 10/40; G06N 10/70

(52) U.S. Cl. CPC G06N 10/20; G06N 10/40; G06N 10/70

(57) ABSTRACT

A quantum computer prepares a logical qubit in a selected state by obtaining a steering circuit. The steering circuit is a quantum circuit comprising one or more quantum interactions between at least one detector qubit and at least one system qubit that is performable by the quantum computer. The quantum computer comprises a plurality of physical qubits that includes the at least one detector qubit and the at least one system qubit. The quantum computer performs one or more iterations of causing one or more detector qubits of the plurality of physical qubits to be initialized into an initial state, causing performance of the steering circuit, and causing measurement of the one or more detector qubits. The quantum computer determines that the logical qubit is in the selected state. The quantum computer may then use the logical qubit in performance of a quantum program.

### CROSS-REFERENCE TO RELATED APPLICATION(S)

This application claims priority to U.S. Application No. 63/609,493, filed Dec. 13, 2023, the content of which is incorporated herein by reference in its entirety.

### GOVERNMENT SUPPORT STATEMENT

This invention was made with government support under 1908131 awarded by the National Science Foundation. The government has certain rights in the invention.

### TECHNICAL FIELD

The present disclosure relates to state preparation of logical qubits using quantum steering. An example embodiment relates to the use of quantum steering to prepare a state of logical qubit organized as a surface code for quantum error correction (e.g., a surface error correcting code).

### BACKGROUND

Quantum computing can efficiently solve many hard problems significantly faster than its classical counterpart. Quantum state preparation is one of the critical steps in quantum computing that prepares qubits to be acted upon via a quantum program configured to perform a quantum computation. A quantum program includes one or more quantum circuits that are each a respective computational routine consisting of coherent quantum operations on quantum data, such as qubits. In other words, a quantum circuit is an ordered sequence of quantum gates, measurements, and resets. Performance of a quantum computation is accomplished through performance of a quantum program may include one or more quantum circuits. In order for the results of the quantum program to be interpretable (e.g., to determine a result of the quantum computation), the qubits must be in a known state at the beginning of the quantum program. In instances where the qubits are not in a known state at the beginning of the quantum program, the results of the quantum program are not able to be meaningfully interpreted.

Moreover, while the quantum mechanical property of entanglement provides enhanced computational abilities, qubits may also entangle with unwanted degrees of freedom (e.g., the environment), leading to decoherence and a loss of information. In other words, the quantum computer must satisfy two conflicting requirements. Qubits need to be externally controlled, measured, and entangled. On the other hand, qubits must be isolated from their environment to avoid unwanted entanglement. As a result of these conflicts, quantum computers will be noisy, where errors propagate and grow during the execution. Surface codes provide a promising path towards large-scale fault-tolerant quantum computers. However, their theoretical realization is hindered by a number of technical implementation details, including the initialization of an encoded quantum state on contemporary quantum computers.

### BRIEF SUMMARY OF EXAMPLE EMBODIMENTS

Various embodiments provide methods, systems, apparatus, computer program products, and/or the like for preparing logical qubits, such as surface code encoded logical qubits, using quantum steering. For example, the surface code encoded logical qubits may be used to perform quantum error correction (e.g., the logical qubits may be surface error correcting codes). For example, various embodiments, use quantum steering to steer system qubits that make up the logical qubits into a selected state via interactions with detector qubits, where the quantum state of the detector qubits are measured after performance of the interactions.

In an example embodiment, a quantum computer includes a plurality of physical qubits, a qubit measurement system, a qubit manipulation system, and a controller. The qubit measurement system is configured to measure, detect, and/or read the quantum state of one or more qubits of the plurality of physical qubits. The qubit manipulation system is configured to manipulate the quantum state of one or more qubits. The controller is configured to control operation of the qubit manipulation system and receive input from the qubit measurement system. The controller is configured to obtain a steering circuit. The steering circuit is a quantum circuit comprising one or more quantum interactions between at least one detector qubit and at least one system qubit that is performable by the quantum computer and is configured to steer the quantum state of a logical qubit or the system qubits of a logical qubit toward a selected logical qubit state (e.g., a surface code) and/or respective intermediate system qubit states. The controller is further configured to perform one or more iterations of causing the qubit manipulation system to initialize one or more detector qubits of the plurality of physical qubits into an initial state, causing the qubit manipulation system to perform the steering circuit, and causing the qubit measurement system to measure respective states of the one or more detector qubits. The controller is further configured to determine that the logical qubit is in a selected state (e.g., a surface code).

According to a first aspect, a method for preparing a logical qubit in a selected state is provided. In an example embodiment, the method includes obtaining, by a controller of quantum computer, a steering circuit. The steering circuit is a quantum circuit comprising one or more quantum interactions between at least one detector qubit and at least one system qubit that is performable by the quantum computer. The quantum computer includes a plurality of physical qubits that includes the at least one detector qubit and the at least one system qubit. The method further includes performing, by the quantum computer, one or more iterations of causing one or more detector qubits of the plurality of physical qubits to be initialized into an initial state, causing the quantum computer to perform the steering circuit, and causing measurement of the one or more detector qubits. The method further comprises determining (e.g., by the quantum computer) that the logical qubit is in the selected state.

According to another aspect, a quantum computer configured to use quantum steering to prepare a logical qubit in a selected state is provided. In an example embodiment, the quantum computer includes a plurality of physical qubits; a qubit measurement system; a qubit manipulation system; and a controller configured to control operation of the qubit manipulation system and receive input from the qubit measurement system. The controller is configured to at least obtain a steering circuit. The steering circuit is a quantum circuit comprising one or more quantum interactions between at least one detector qubit and at least one system qubit that is performable by the quantum computer. The plurality of physical qubits includes the at least one detector qubit and the at least one system qubit. The controller is further configured to at least perform one or more iterations of causing the qubit manipulation system to initialize one or more detector qubits of the plurality of physical qubits into an initial state, causing the qubit manipulation system to perform the steering circuit, and causing the qubit measurement system to measure respective states of the one or more detector qubits. The controller is further configured to at least determine that the logical qubit is in a selected state.

According to another aspect, a computer program product comprising at least one non-transitory storage medium is provided. In an example embodiment, the at least one storage medium stores computer executable instructions configured for causing a logical qubit to be prepared in a selected state. The executable instructions are configured to, when executed by a controller of a quantum computer, cause the quantum computer to obtain a steering circuit. The steering circuit is a quantum circuit comprising one or more quantum interactions between at least one detector qubit and at least one system qubit that is performable by the quantum computer. The quantum computer comprises a plurality of physical qubits that includes the at least one detector qubit and the at least one system qubit. The executable instructions are further configured to, when executed by the controller of the quantum computer, cause the quantum computer to perform one or more iterations of causing a qubit manipulation system of the quantum computer to initialize one or more detector qubits of the plurality of physical qubits into an initial state, causing the qubit manipulation system to perform the steering circuit, and causing a qubit measurement system of the quantum computer to measure respective states of the one or more detector qubits. The executable instructions are further configured to, when executed by the controller of the quantum computer, cause the quantum computer to determine that the logical qubit is in a selected state.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a schematic diagram illustrating an example system, according to an example embodiment.

FIG. 2 is a schematic diagram illustrating an example surface code encoded logical qubit comprising a plurality of system qubits, according to an example embodiment.

FIG. 3A is a circuit visualization of the performance of a steering circuit, according to an example embodiment.

FIG. 3B visualizes the expectation value of the surface code at a plurality of points during a steering process, according to an example embodiment.

FIG. 3C visualizes the evolution of a four qubit system being steered directly into the ground state of the system using a steering process, according to an example embodiment.

FIG. 4 provides a plot illustrating the number N of iterations of a quantum steering process performed as a function of coupling strength J for various numbers of qubits acted upon by the quantum steering process, according to example embodiments.

FIG. 5 is a flowchart illustrating processes, procedures, and/or operations performed by a quantum computer to prepare a logical qubit in a selected state, according to an example embodiment.

FIG. 6 is a schematic representation of a detector state space of a detector qubit, according to an example embodiment.

FIG. 7 is a flowchart illustrating processes, procedures, and/or operations performed by a quantum computer to prepare a logical qubit in a selected state, according to another example embodiment.

FIG. 8 provides a plot illustrating amounts of time for preparing a logical qubit in a selected state for various numbers of qubits, according to respective embodiments.

FIG. 9 provides a schematic diagram of an example classical computing entity that may be used in accordance with an example embodiment.

### DETAILED DESCRIPTION OF SOME EXAMPLE EMBODIMENTS

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Various embodiments provide methods, systems, apparatus, computer program products, and/or the like for preparing logical qubits, such as surface code encoded logical qubits, using quantum steering. For example, various embodiments, use quantum steering to steer system qubits that make up the logical qubits into a selected state via interactions with detector qubits, where the quantum state of the detector qubits are measured after performance of the interactions. In certain embodiments, a logical qubit of a surface error correcting code or quantum error correction using surface code scheme is initialized.

Quantum computing is expected to significantly out-perform classical computing on many hard problems due to quantum mechanical effects such as entanglement and superposition. While a memory component of a classical computer (e.g., a bit) can only be in one possible state at a time, a memory component of a quantum computer (e.g., a qubit) can be in an arbitrary combination or superposition of states at the same time. Unfortunately, quantum computing also introduces a significant level of noise and uncertainty compared to classical computing. In some instances, the errors caused by noise and uncertainty in a quantum computation grow and propagate during the performance of the quantum computation. The results of the quantum computation are therefore not able to be usefully interpreted.

Fault tolerant quantum computing uses logical qubits comprising a plurality of system qubits. In various embodiments, the system qubits are physical qubits of a quantum computer and may be photons, coherent states of light, electrons, atomic nuclei, optical lattices, Josephson junctions, quantum dots, ions, atoms, non-abelian anyons, vibrational states of a particle, van der Waals heterostructures, and/or other quantum-mechanical systems. In various embodiments, the system qubits of the logical qubits are organized based on a quantum error correction (QEC) code, such as a surface code. Initializing and/or performing state preparation of a surface code encoded logical qubit includes entangling the system qubits of the logical qubit into a particular multi-qubit state.

While surface codes provide a promising path towards large-scale fault-tolerant quantum computers, their theoretical realization is hindered by a number of technical implementation details, including the initialization of an encoded quantum state on contemporary quantum computers. Conventional techniques for performing the initializing and/or state preparation of logical qubits requires performance of many quantum gates and many measurements, resulting in a large amount of space and time overhead for initializing and/or performing state preparation of a logical qubit with sufficient fidelity. For example, an initializing routine may be formed, one or more syndromes of the logical qubit may be measured to determine whether the initialization was successful. In the frequent situations where the initialization was not successful, the initialization routine is performed repeatedly until the initialization is completed successfully. Therefore, technical problems exist regarding initialization and/or state preparation of logical qubits.

Various embodiments provide technical solutions to these technical problems. In particular, various embodiments employ quantum steering to prepare a surface code encoded logical qubit in a selected state with high fidelity. Quantum steering is a phenomenon in quantum mechanics whereby measurements on one system influences the state of another entangled system. In various embodiments, detector qubits are initialized into an initial state and then entangled with one or more system qubits of a logical qubit via a steering circuit. The detector qubits are then measured to cause the respective quantum wave functions of the detector qubits to collapse to respective single states. The steering circuit is configured to steer the system qubits of the logical qubit to either a respective selected state of the individual system qubits or to a selected state of the logical qubit. When the steering circuit is configured to steer the system qubits of the logical qubit into the respective selected state of the individual system qubits, a sequence of entangling gates is used to entangle the system qubits of the logical qubit into the selected state of the logical qubit. For example, quantum steering can address the technical problems of realizing logical qubit initialization by detecting an erroneous qubit and initializing it to the corrected state so that the quantum computation can continue without disruption. In various embodiments, multiple logical qubits may be prepared into the selected state and/or initialized at the same time.

By steering the system qubits of the logical qubit toward the respective selected state of the individual system qubits or to a selected state of the logical qubit (e.g., surface code), the logical qubit can be prepared into the selected state efficiently (e.g., with reduced space and/or time overhead) and with high fidelity. Therefore, various embodiments provide improvements to the fields of quantum computing, fault tolerant quantum computing, and logical qubit state preparation and/or initialization.

### Example System Architecture

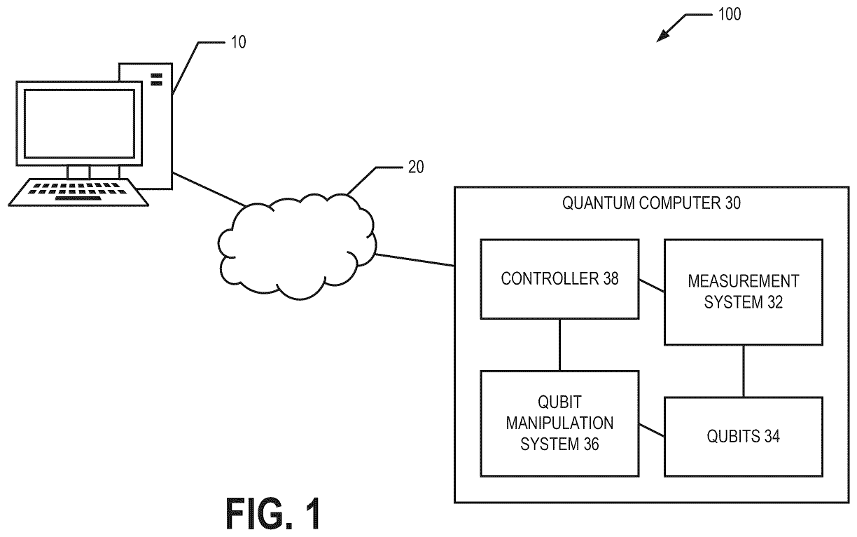

FIG. 1 provides a block diagram of an example system 100 that maybe used in various embodiments. In various embodiments, the system 100 comprises a classical computing entity 10 and a quantum computer 30.

The quantum computer 30 comprises a controller 38, a qubit manipulation system 36, a plurality of physical qubits 34, and a qubit measurement system 32. In various embodiments, the controller 38 is configured to control operation of the qubit manipulation system 36 and to receive input from the qubit measurement system 32. The qubit manipulation system 36 is configured to perform quantum logic operations and/or gates on the physical qubits 34 and/or logical qubits formed from respective pluralities of physical qubits. The qubit measurement system 32 is configured to measure the respective quantum states of the physical qubits 34 and/or logical qubits formed from respective pluralities of physical qubits. The qubit measurement system 32 provides sensor signals and/or an indication of processing sensor signals to the controller 38 that provide an indication of the measured respective quantum states of the physical qubits 34 and/or logical qubits. For example, the controller 38 may cause the quantum computer 30 to perform a quantum circuit and/or program by causing the qubit manipulation system 36 to perform a sequence of quantum logic operations indicated by the quantum circuit on the one or more physical qubits 34. In various embodiments, the quantum computer 30 is configured to perform quantum logic operations on one or more physical qubits 34 thereof and/or logical qubits formed of respective pluralities of physical qubits 34. The quantum computer 30 may then use the qubit measurement system 32 to measure the respective quantum states of one or more of the physical qubits 34 and/or logical qubits as a result of the performance of the quantum circuit and/or program by the quantum computer 30.

In various embodiments, the controller 38 comprises one or more classical and/or semiconductor-based processing elements (e.g., processors, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, graphics processing units (GPUs), central processing units (CPUs), and/or other processing circuitry) and classical and/or semiconductor-based memory (e.g., ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like). The classical and/or semiconductor-based memory stores executable instructions configured, to when executed by the classical and/or semiconductor-based processing elements of the controller 38, cause the controller 38 to control operation of the qubit manipulation system 36 to cause performance of a quantum circuit.

In various embodiments, the qubit manipulation system 36 comprises current and/or voltage sources (e.g., digital-to-analog converters (DACs), analog-to-digital converters (ADCs), arbitrary waveform generators (AWGs), and/or the like), lasers, microwave sources, magnetic field sources, and/or other components configured to interact with the physical qubits 34 and/or generate a signal configured to interact with the physical qubits 34. In various embodiments, the system qubits are physical qubits of a quantum computer and may be photons, coherent states of light, electrons, atomic nuclei, optical lattices, Josephson junctions, quantum dots, ions, atoms, non-abelian anyons, vibrational states of a particle, van der Waals heterostructures, and/or other quantum-mechanical systems. In various embodiments, the qubit measurement system 32 comprises one or more components configured to determine a quantum state of one or more of the physical qubits 34. For example, the qubit measurement system 32 comprises photodetectors (e.g., photodiodes, photomultiplier tubes, charge-coupled device (CCD) photosensors, and/or the like), magnetometers, oscillators, and/or the like. For example, the qubit manipulation system 36 and the qubit measurement system 32 comprise components configured for manipulating and/or measuring a quantum state, respectively, of the physical qubits 34 of the quantum computer 30.

In various embodiments, the quantum computer 30 is in communication with a classical computing entity 10 via one or more wired or wireless networks 20 and/or via direct wired and/or wireless communications. For example, the classical computing entity 10 may be configured to provide the quantum circuit and/or program to the quantum computer 30 and receive measured values corresponding to the qubit measurements indicating the quantum states of the one or more physical qubits 34 and/or logical qubits as a result of the performance of the quantum circuit and/or program by the quantum computer 30.

### Example State Preparation of a Logical Qubit

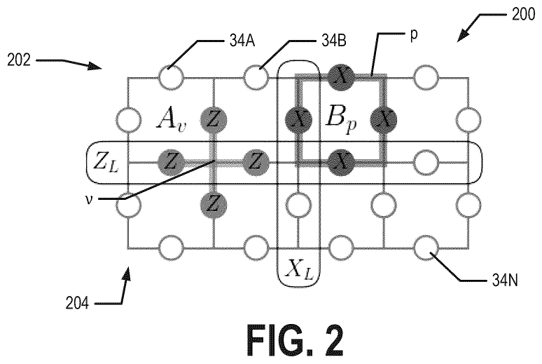

Quantum error-correcting codes (QECCs) provides a realistic path towards fault-tolerant quantum computing. QECCs have three main requirements: (1) provide an encoding of physical qubits to logical qubits, (2) the ability to detect when an error has occurred, and (3) a mechanism to correct the logical qubit. In other words, by creatively entangling several physical qubits as one logical qubit, errors can be detected and corrected. As a particular promising example, surface codes, an example of which is illustrated in FIG. 2, build logical qubits by assuming topological features of physical qubits 34. Specifically, surface codes assume the physical layout of qubits is given by a lattice. For example, the logical qubit 200 comprises a plurality of physical qubits 34 that are arranged into rows 202 and columns 204.

Surface codes are defined on a plane lattice (e.g., having one or more rows 202 and one or more columns 204). As depicted in FIG. 2, physical qubits 34 (e.g., 34A, 34B, . . . , 34N) are placed on each edge of a square in the lattice. The encoding of logical qubits is based on two operators that perform respective local operations. These are known as vertex and plaquette operators, and are defined as follows:

$${A}_{v} = {\prod }_{i ∈ p} {Z}_{i} and {B}_{p} = {\prod }_{i ∈ p} {X}_{i} ,$$

where Aᵥ enacts the Pauli-Z rotation on each qubit around a vertex v, and Bₚ enacts the Pauli-X rotation on each qubit that makes up a plaquette p. All the terms of Aᵥ and Bₚ mutually commute, such that [Aᵥ, Bₚ]=0, and so a state |v [symbol] can be defined to be a simultaneous eigenstate of both terms

$$∀ v : {A}_{v} \vert ψ 〉 = \vert ψ 〉 ∀ p : {B}_{p} \vert ψ 〉 = \vert ψ 〉 .$$

The state |ψ [symbol] defines the codespace of the logical qubit 200 encoded by the surface code. Logical operators are then defined to operate within the codespace, and hence logical qubits are realized.

Before the logical qubits can be used to perform a quantum program, the logical qubits are initialized into a selected state. This process is generally referred to as state preparation. In various embodiments, the selected state is the ground state (e.g., lowest energy state) of a logical qubit, through various other states may be selected as the selected state as appropriate for the application and/or logical qubit topology.

Conventional approaches for state preparation—including “repeat until success”—have two practical limitations: (i) they require many gates (area overhead) to initialize a logical qubit into a selected state, and (ii) they require many measurements (timing overhead) to ascertain high fidelity of the selected state of the logical qubit.

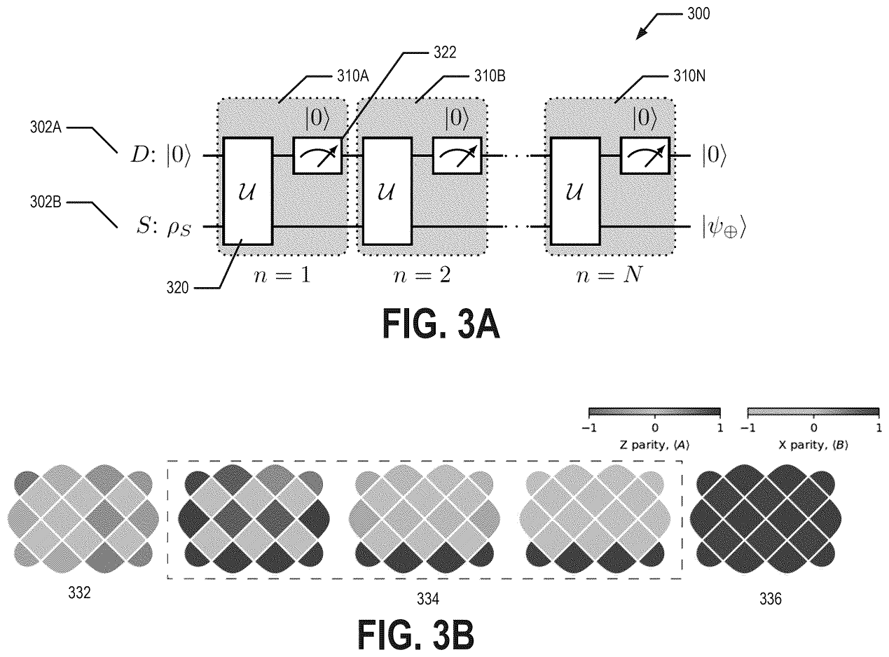

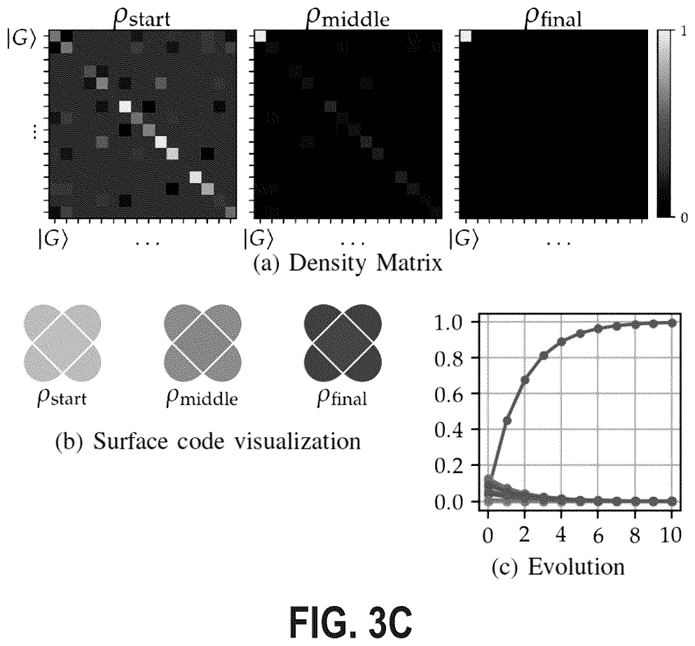

Various embodiments provide technical solutions to these technical challenges by providing a mechanism to initialize the logical qubits into the selected state using quantum steering. Quantum steering, as first coined by Schrödinger, is a phenomenon in quantum mechanics whereby measurements on one system influences the state of another entangled system. As a brief visualization, FIG. 3A represents the steering protocol 300. The illustrated steering protocol includes one detector qubit D that is evolved along a detector qubit timeline 302A and one system qubit S that is evolved along a system qubit timeline 302B. In various embodiments, the plurality of physical qubits 34 comprises a plurality of detector qubits D and a plurality of system qubits S. The logical qubits are formed from respective pluralities of system qubits. In various embodiments, the detector qubits D and the system qubits S are physically similar and/or identical but are used for performing different functions by the quantum computer 30. For example, the system qubits S are used to form logical qubits and the detector qubits D are used as ancilla qubits.

The detector qubit D begins the steering protocol 300 in an initial state (e.g., the |0> single qubit state). The system qubit S begins the steering protocol 300 in an arbitrary state represented by the density matrix ρ_{S}. For example, the system qubit S may begin the steering protocol 300 in a random superposition of states. One or more iterations of the steering process 310 (e.g., 310A, 310B, 310C) are performed. Each steering process 310 starts with the detector qubit D in the initial state (e.g., in the |0> state) and includes performance of steering circuit 320 and measurement 322 of the detector qubit D. The detector qubit D is reset to the initial state (e.g., the |0> state) prior to performance of the next iteration of the steering process 310. Each iteration of the steering process 310 steers the state of the system qubit S toward the selected state such that after performance of the Nth iteration of the steering process 310N, the system qubit is in the selected state |ψ_{⊕} [symbol] .

In various embodiments, the steering circuit is a quantum circuit comprising one or more quantum interactions between at least one detector qubit and at least one system qubit that is performable by the quantum computer 30. The steering circuit is configured to steer the system qubits of a logical qubit to either a respective selected state of the individual system qubits or to a selected state of the logical qubit. For example, the steering circuit is configured to enact a unitary operator U on the at least one detector qubit and the at least one system qubit. In various embodiments, the unitary operator U is functionally represented as U=e^{-iJH}, where e is Euler's number, i is the square root of negative one, J is a coupling strength corresponding to the quantum computer 30, and H is the Hamiltonian for a system being acted upon by the steering circuit. In various embodiments, the coupling strength J is a tunable coupling strength that determines a convergence rate of the logical qubit being prepared into the selected state.

In various embodiments, the system being acted upon by the steering circuit comprises one or more detector qubits and the plurality of system qubits that form the logical qubit. For example, the steering circuit is configured to steer the system qubits of a logical qubit to a selected state of the logical qubit. In such embodiments, the Hamiltonian is a sum over an index of vector products of a first operator that links the initial state to an orthogonal space of a detector state space and a second operator that links the selected state of a state space of the plurality of system qubits to a respective state corresponding to the index in an orthogonal space of the state space of the plurality of system qubits and their Hermitian conjugates. This technique of state preparation of a logical qubit is referred to herein as a direct quantum steering state preparation.

In various embodiments, the system being acted upon by the steering circuit comprises one detector qubit and one system qubit. For example, the steering circuit is configured to steer the system qubits of a logical qubit to a respective selected state of the individual system qubits. Once each of the system qubits have converged to the respective selected state of the individual system qubits, a sequence of entangling gates, such as controlled not (CNOT) gates and/or the like are performed to entangle the system qubits of the logical qubit into the selected state of the logical qubit. In such embodiments, the Hamiltonian is a vector product of a first operator that links the initial state to an orthogonal space of a detector state space and a second operator that links the selected state of the system qubit to an orthogonal space of a system qubit state space and their Hermitian conjugates. This technique of state preparation of a logical qubit is referred to herein as an indirect quantum steering state preparation.

In various embodiments, one or more iterations of the steering process 310 are performed to cause the system qubits of a logical qubit to converge to either a respective selected state of the individual system qubits or a selected state of the logical qubit. In various embodiments, various tests of convergence may be used to determine when and/or whether the system qubits of a logical qubit to converge to either a respective selected state of the individual system qubits or a selected state of the logical qubit. One example of such a test is the number of iterations of the quantum steering process performed.

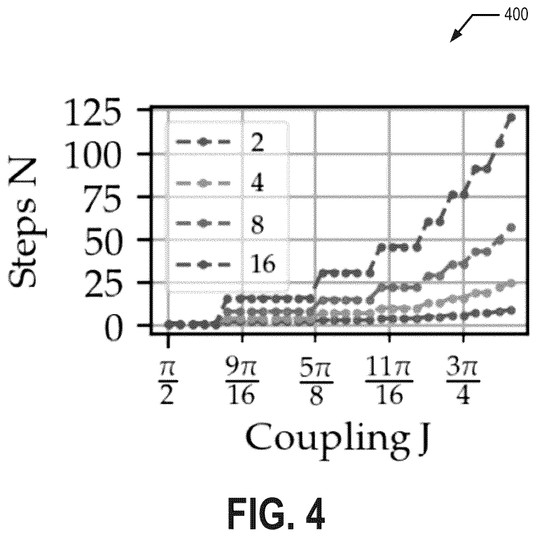

In various embodiments, N iterations of the steering process 310 are performed to cause the system qubits of a logical qubit to converge to either a respective selected state of the individual system qubits or a selected state of the logical qubit, where N is a positive integer. In various embodiments, the number of iterations N is determined based at least in part on the coupling strength J which is a property of the quantum computer 30. For example, the coupling strength of a quantum computer using superconducting qubits may be different from the coupling strength of a quantum computer using photonic qubits. FIG. 4 provides a plot 400 that illustrates the number N of steps or iterations as a function of coupling strength J for various numbers of qubits the steering process 310 acts upon (e.g., the sum of the number of detector qubits and the number of system qubits acted upon by the unitary operator U).

FIG. 3B provides a visualization of surface code at a plurality of points in time before (e.g., initial state 332), during (e.g., intermediate states 334), and after (e.g., final state 336) performance of a steering procedure. In the initial state 332, the qubits of the surface code have random states and therefore may contain both separable and entangled states. As shown by intermediate states 334, the steering procedure steers the qubits of the surface code to converge to a superposition state of

$$\frac{1}{\sqrt{2}} ( \vert 0 〉 + \vert 1 〉 ) .$$

Entangling CNOT gates are applied to the qubits of the surface code to finalize the ground state of the surface code, as shown by the final state 336.

FIG. 3C provides a visualization of using a steering procedure to initialize a surface code including four physical qubits into the ground state |G [symbol] of the surface code. Section (a) of FIG. 3C illustrates the initial density matrix ρₛₜₐᵣₜ on the left, an intermediate state density matrix ρ_{middle} (e.g., a state that occurs during the performance of the steering procedure), and the final density matrix ρ_{final} on the right. The density matrices of the four qubits are illustrated as color maps in the basis spanned by the desired ground state |G [symbol] and the orthogonal complement |G [symbol] ^{⊥}. As shown by the sequence of density matrices, the orthogonal components decay, while the ground state is maximized. Section (b) of FIG. 3C provides a visualization of the expectation values of Aᵥ and Bₚ, where Aᵥ enacts the Pauli-Z rotation on each qubit around a vertex v, and Bₚ enacts the Pauli-X rotation on each qubit that makes up a plaquette p, as shown in FIG. 2. Section (c) of FIG. 3C provides a plot illustrating the evolution of the diagonal elements of the density matrix, [symbol] G|ρ|G [symbol] , with iterations of the steering process 310, as the density matrix converges t the ground state |G [symbol] .

### Example Performance of an Indirect Quantum Steering State Preparation

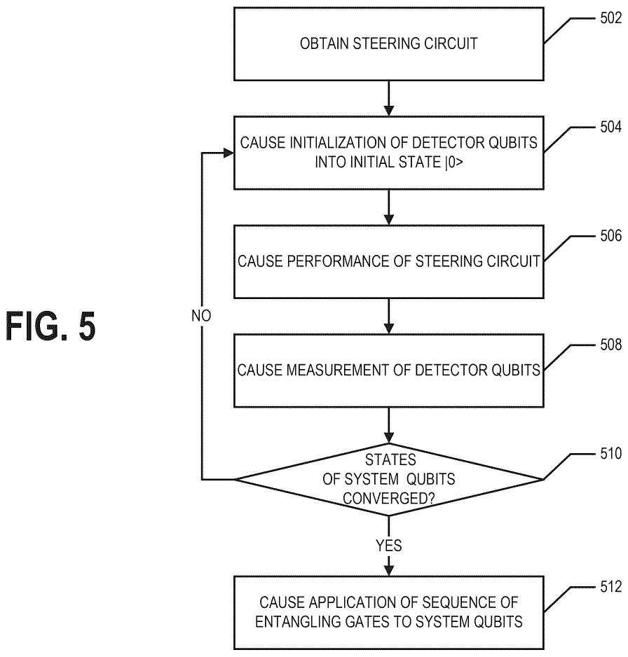

FIG. 5 provides a flowchart illustrating various processes, procedures, operations, and/or the like performed by a quantum computer 30 to perform an indirect quantum steering state preparation. In various embodiments, performing an indirect quantum steering state preparation includes performing N iterations of a quantum steering process to cause the system qubits of a logical qubit to converge to a respective selected state of the individual system qubits and then performing a sequence of entangling gates to entangle the system qubits into the selected state of the logical qubit. For example, the indirect quantum steering state preparation is configured to prepare the individual quantum states of the system qubits of the logical qubit and then to entangle the system qubits into the selected state of the logical qubit.

Starting at step 502, a steering circuit is obtained. In various embodiments, the controller 38 of the quantum computer 30 obtains a steering circuit. In various embodiments, the steering circuit is received from the classical computing entity 10, accessed from a classical and/or semiconductor-based memory of the controller 38, determined and/or generated by a classical and/or semiconductor-based processing element of the controller 38 (e.g., via execution of executable instructions stored in the classical and/or semiconductor-based memory of the controller 38), and/or the like.

In various embodiments, the steering circuit is configured to enact a unitary operator Uₗ, wherein the unitary operator Uₗ is functionally representable as (e.g., can be represented by the functional representation) Uₗ=e^{-iJH}, where e is Euler's number, i is the square root of negative one, J is a coupling strength corresponding to the quantum computer, and H is the Hamiltonian for a system including one system qubit and one detector qubit of the plurality of physical qubits. In various embodiments, the Hamiltonian H is a vector product of a first operator that links the initial state to an orthogonal space of a detector state space and a second operator that links the selected state of the at least one system qubit to an orthogonal space of a system qubit state space and their Hermitian conjugates.

For example, in various embodiments, the Hamiltonian H=|1 [symbol] [symbol] 0|⊗|+ [symbol] [symbol] −|+h.c., where h.c. is the Hermitian conjugate of the operator |1 [symbol] [symbol] 0|⊗|+ [symbol] [symbol] −|. In general, the Hermitian conjugate of an operator O, denoted O^{†}, is defined such that [symbol] ψ|O|ψ [symbol] ≡ [symbol] O^{†}ψ|ψ [symbol] . The operator |1 [symbol] [symbol] 0|⊗|+ [symbol] [symbol] −| is the tensor product of a first operator |1 [symbol] [symbol] 0| and a second operator |+ [symbol] [symbol] −|. The first operator |1 [symbol] [symbol] 0| acts on a detector state space. The detector state space is a two-dimensional complex-Hilbert space that is defined at least in part by the initial state |0> and another state |1>. The sub-space of the detector state space that is orthogonal to the initial state |0> is the sub-space defined by the state |1>.

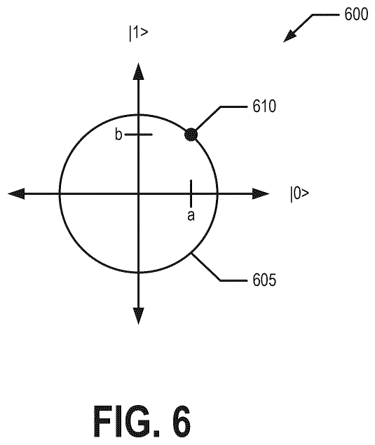

For example, FIG. 6 provides a schematic illustration of the detector state space 600. The axes of the detector state space 600 are the initial state |0> and the state |1>. The state |1> is orthogonal to the initial state |0>. The general state 610 of the detector qubit is located on the circle 605 such that the detector qubit is in a state a|0>+b|1>, where a²+b²=1, for real numbers a and b. Since |1> is the orthogonal space of the detector state space with respect to the initial state |0>, the first operator |1 [symbol] [symbol] 0| links the initial state |0> to the orthogonal space |1> of the detector state space.

The second operator |+ [symbol] [symbol] −| links an orthogonal space of the system qubit state space |−> (orthogonal with respect to the selected state |+>) to the selected state |+> of an individual system qubit. In an example embodiment, the selected state

$$\vert + 〉 = \frac{1}{\sqrt{2}} ( \vert 0 〉 + \vert 1 〉 )$$

and the orthogonal state

$$\vert - 〉 = \frac{1}{\sqrt{2}} ( \vert 0 〉 + \vert 1 〉 ) .$$

For example, the system qubit space is a two-dimensional complex-Hilbert space that is defined at least in part by the selected state |+> and another state |−>. The sub-space of the system qubit state space that is orthogonal to the selected state |+> is the sub-space defined by the state |−>. For example, the system qubit state space looks similar to the detector state space 600 but with the axes as the states |+> and |−> rather than the states |0> and |1>.

Various algorithms exist for generating a quantum circuit that enacts a unitary operator. For example, for a particular quantum computer, various algorithms exist for generating a specific set of operations to be performed by the particular quantum computer to enact a unitary operator (and/or a set or sequence of unitary operators). In various embodiments, the steering circuit is determined and/or generated as a quantum circuit configured to enact the unitary operator Uₗ=e^{-iJH}, where J is the quantum computer specific coupling strength and the Hamiltonian H describes the system of a system qubit and a detector qubit. For example, in various embodiments, the Hamiltonian H=|1 [symbol] [symbol] 0|⊗|+ [symbol] [symbol] −|+h.c.

In various embodiments, the classical computing entity 10 determines the steering circuit and provides the steering circuit to the controller 38 (e.g., via one or more wired and/or wireless networks 20 and/or via a wired and/or wireless direct connection). In various embodiments, the quantum computer 30 (e.g., the controller 38) obtains the steering circuit by receiving a steering circuit provided (e.g., transmitted) by the classical computing entity 10. In various embodiments, the quantum computer (e.g., the controller 38) receives the steering circuit and stores the steering circuit in the classical and/or semiconductor-based memory of the controller 38. The quantum computer 30 (e.g., the controller 38) may obtain the steering circuit by accessing it from the classical and/or semi-conductor-based memory.

In an example embodiment, the quantum computer 30 (e.g., controller 38) is configured to determine the quantum circuit based at least in part on system information including the selected state of the individual system qubits, the system qubit state space, the initial state of the detector qubit, the detector qubit state space, the coupling strength J, and/or the like. For example, the quantum computer 30 (e.g., controller 38) may obtain the quantum circuit by generating the quantum circuit based at least in part on the system information. In an example embodiment, the quantum computer 30 (e.g., controller 38) is configured to determine the quantum circuit based at least in part on the system information and store the quantum circuit to the classical and/or semiconductor-based memory of the controller 38 such that the quantum computer 30 (e.g., controller 38) may obtain the quantum circuit by accessing the quantum circuit from the classical and/or semiconductor-based memory of the controller 38.

Returning to FIG. 5, steps 504, 506, and 508 are iterated one or more times (e.g., N times). At step 504, the controller 38 causes the qubit manipulation system 36 to initialize one or more detector qubits into the initial state |0>. In various embodiments, the process of initializing the one or more detector qubits into the initial state |0> will be specific to the particular quantum computer 30 being used.

At step 506, the controller 38 causes the qubit manipulation system 36 to perform the steering circuit. For example, the qubit manipulation system 36 entangles respective pairs of detector qubits and system qubits via performance of the steering circuit. For example, a logical qubit is built from a plurality of system qubits. One or more of the system qubits of the plurality of system qubits are each entangled with a respective detector qubit via a respective instance and/or performance of the steering circuit. In various embodiments, multiple instances and/or performances of the steering circuit may be performed simultaneously, concurrently, and/or at least partially overlapping in time.

At step 508, the qubit measurement system 32 performs a respective measurement of each of the detector qubits. For example, the qubit measurement system 32 may interact with each of the detector qubits such that respective waveforms of the detector qubits are caused to collapse into respective single states. Because of the entanglement of a respective detector qubit with a respective system qubit, the collapse of the waveform of the respective detector qubit affects the quantum state of the respective system qubit. This effect steers the quantum state of the respective system qubit toward the selected state of the individual system qubits (e.g., a selected state within the system qubit state space).

At step 510, the quantum computer 30 (e.g., controller 38) determines whether the states of the one or more system qubits have converged to the selected state of the individual system qubits (e.g., a selected state within the system qubit state space). In various embodiments, various tests may be used to determine whether or not the states of the one or more system qubits have converged to the selected state of the individual system qubits (e.g., a selected state within the system qubit state space).

In an example embodiment, the quantum computer 30 (e.g., controller 38) determines that the states of the one or more system qubits have converged to the selected state of the individual system qubits (e.g., a selected state within the system qubit state space) when the steering process 310 (e.g., steps 504, 506, and 508) have been performed N times. For example, responsive to determining that the steering process 310 (e.g., steps 504, 506, and 508) have been performed less than N times, the quantum computer 30 (e.g., controller 38) determines that the states of the one or more system qubits have not converged to the selected state of the individual system qubits (e.g., a selected state within the system qubit state space) and the steering process 310 is performed again. For example, responsive to determining that the steering process 310 (e.g., steps 504, 506, and 508) have been performed N times or more, the quantum computer 30 (e.g., controller 38) determines that the states of the one or more system qubits have converged to the selected state of the individual system qubits (e.g., a selected state within the system qubit state space) and the process continues to step 512.

At step 512, the quantum computer 30 (e.g., controller 38) causes the qubit manipulation system 36 to apply a sequence of entangling gates to the system qubits of the logical qubit. In various embodiments, the entangling gates may be any entangling gates that are native to the underlying architecture of the quantum computer 30, subject to local corrections using single-qubit rotations. In an example embodiment, the entangling gates are controlled not (CNOT) gates. In various embodiments, the sequence of entangling gates is configured to entangle the system qubits of the logical qubit into a selected state |Ω_{⊕} [symbol] of the logical qubit. In an example embodiment, the selected state is a ground state of the logical qubit. For example, in an example embodiment, the selected stat

$${{\vert {ψ}_{⊕} 〉 = \frac{1}{\sqrt{2}} ( \vert 0 〉}^{⊗ n} + \vert 1 〉}^{⊗ n} ) e$$

such that the n system qubits of the logical qubit are each in the selected state

$$\vert + 〉 = \frac{1}{\sqrt{2}} ( \vert 0 〉 + \vert 1 〉 )$$

of the individual system qubit state space and then entangled with one or more other of the n system qubits of the logical qubit. In various embodiments, n is a positive integer.

Once the logical qubit is prepared and/or initialized into the selected state |ψ_{⊕} [symbol] , the quantum computer (e.g., the controller 38) may perform a quantum program using the logical qubit. For example, the controller 38 may control the qubit manipulation system 36 to cause performance of a sequence of quantum operations on one or more logical qubits of the quantum computer (each comprising a respective plurality of system qubits) to perform a quantum program. The qubit measurement system 32 may determine the quantum state of one or more of the system qubits and/or logical qubits such that a result of performing the quantum program may be determined and interpreted (e.g., by the controller 38 and/or the classical computing entity 10).

### Example Performance of a Direct Quantum Steering State Preparation

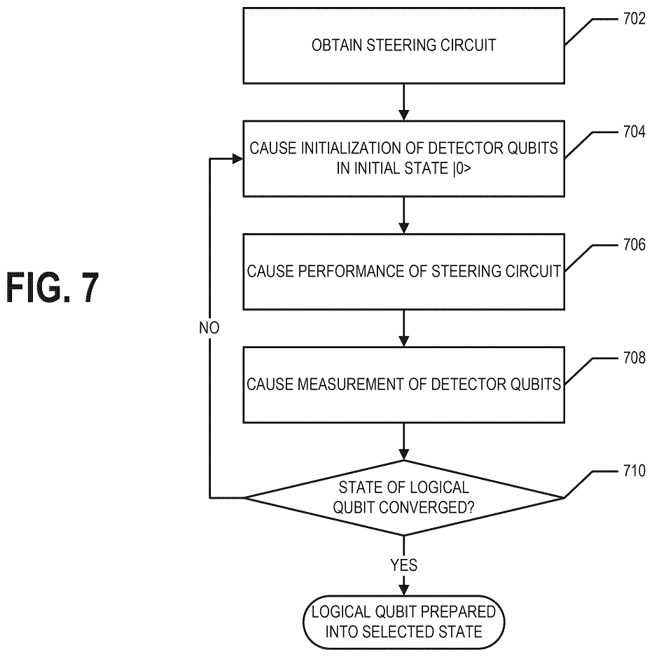

FIG. 7 provides a flowchart illustrating various processes, procedures, operations, and/or the like performed by a quantum computer 30 to perform a quantum steering state preparation. In various embodiments, performing a quantum steering state preparation includes performing N iterations of a quantum steering process to cause the system qubits of a logical qubit to converge to a selected state of the logical qubit. For example, performance of a quantum steering state preparation steers the system qubits directly into the selected state of the logical qubit.

Starting at step 702, a steering circuit is obtained. In various embodiments, the controller 38 of the quantum computer 30 obtains a steering circuit. In various embodiments, the steering circuit is received from the classical computing entity 10, accessed from a classical and/or semiconductor-based memory of the controller 38, determined and/or generated by a classical and/or semiconductor-based processing element of the controller 38 (e.g., via execution of executable instructions stored in the classical and/or semiconductor-based memory of the controller 38), and/or the like.

In various embodiments, the steering circuit is configured to enact a unitary operator Uₙ, wherein the unitary operator Uₙ is functionally representable as (e.g., can be represented by the functional representation) Uₙ=e^{-iJH}, where e is Euler's number, i is the square root of negative one, J is a coupling strength corresponding to the quantum computer, and H is the Hamiltonian for a system including n system qubits and one or more detector qubits, where n is the number of system qubits that form the logical qubit (e.g., a positive integer). In various embodiments, the Hamiltonian H is a vector product of a first operator that links the initial state of a detector qubit to an orthogonal space of a detector state space and a second operator that links an orthogonal space of a system qubit state space (orthogonal with respect to the selected state) to the selected state of the logical qubit and their Hermitian conjugates.

For example, in various embodiments, the Hamiltonian H is an indexed sum (e.g., over an index k) of vector/tensor products of a first operator that links the initial state to an orthogonal space of a detector state space and a (indexed) second operator that links the selected state of a state space of the plurality of system qubits to a respective state corresponding to the index in an orthogonal space of a logical qubit state space and their Hermitian conjugates. For example, the Hamiltonian H may be expressed as

$$H = {\sum }_{k} \vert 1 〉 〈 0 \vert ⊗ {U}_{s}^{k} + h . c . ,$$

where h.c. is the Hermitian conjugate of the operator

$$\vert 1 〉 〈 0 \vert ⊗ {U}_{s}^{k} .$$

In general, the Hermitian conjugate of an operator O, denoted O^{†}, is defined such that [symbol] ψ|O|ψ [symbol] ≡ [symbol] O^{†}ψ|ψ [symbol] . The operator

$$\vert 1 〉 〈 0 \vert ⊗ {U}_{s}^{k}$$

is the vector/tensor product of a first operator |1 [symbol] [symbol] 0| and a (indexed) second operator

$${U}_{s}^{k} .$$

The first operator | [symbol] [symbol] 0| acts on a detector state space. The detector state space is a two-dimensional complex-Hilbert space that is defined at least in part by the initial state |0> and another state |1>. The sub-space of the detector state space that is orthogonal to the initial state |0> is the sub-space defined by the state |1>.

For example, FIG. 6 provides a schematic illustration of the detector state space 600. The axes of the detector state space 600 are the initial state |0> and the state |1>. The state |1> is orthogonal to the initial state |0>. The general state 610 of the detector qubit is located on the circle 605 such that the detector qubit is in a state a|0>+b|1>, where a²+b²=1, for real numbers a and b. Since |1> is the orthogonal space of the detector state space with respect to the initial state |0>, the first operator |1 [symbol] [symbol] 0| links the initial state |0> to the orthogonal space |1> of the detector state space.

The second operator

$${U}_{s}^{k}$$

links the selected state |ψ_{⊕} [symbol] of the logical qubit to a k^{th} state of the logical qubit that is in an orthogonal space of the logical qubit state space with respect to the selected state |ψ_{⊕} [symbol] . For example,

$${U}_{s}^{k †} \vert {ψ}_{⊕} 〉 = \vert {ψ}_{k} 〉 ,$$

where |ψₖ [symbol] is a k^{th} state in the orthogonal space of the logical qubit state space with respect to the selected state |ψ_{⊕} [symbol] . The index k takes integer values 1 to n−1, in an example embodiment. In an example embodiment, the selected state

$${{\vert {ψ}_{⊕} 〉 = \frac{1}{\sqrt{2}} ( \vert 0 〉}^{⊗ n} + \vert 1 〉}^{⊗ n} )$$

is a ground state (e.g., lowest energy state) of the logical qubit. For example, the system qubit space is a 2ⁿ dimensional complex-Hilbert space that is defined at least in part by the selected state |ψ_{⊕} [symbol] and another 2ⁿ−1 states that are orthogonal to the selected state |ψ_{⊕} [symbol] . For example, the logical qubit state space is similar to the detector state space 600, but with a dimensionality of 2ⁿ as a result of the entangling of the n system qubits to form the logical qubit.

Various algorithms exist for generating a quantum circuit that enacts a unitary operator. For example, for a particular quantum computer, various algorithms exist for generating a specific set of operations to be performed by the particular quantum computer to enact a unitary operator (and/or a set or sequence of unitary operators). In various embodiments, the steering circuit is determined and/or generated as a quantum circuit configured to enact the unitary operator Uₙ=e^{-iJH}, where J is the quantum computer specific coupling strength and the Hamiltonian H describes the system of a logical qubit (comprising n>1 system qubits) and one or more detector qubits. For example, in various embodiments, the Hamiltonian

$$H = {\sum }_{k} \vert 1 〉 〈 0 \vert ⊗ {U}_{s}^{k} + h . c ..$$

In various embodiments, the classical computing entity 10 determines the steering circuit and provides the steering circuit to the controller 38 (e.g., via one or more wired and/or wireless networks 20 and/or via a wired and/or wireless direct connection). In various embodiments, the quantum computer 30 (e.g., the controller 38) obtains the steering circuit by receiving a steering circuit provided (e.g., transmitted) by the classical computing entity 10. In various embodiments, the quantum computer (e.g., the controller 38) receives the steering circuit and stores the steering circuit in the classical and/or semiconductor-based memory of the controller 38. The quantum computer 30 (e.g., the controller 38) may obtain the steering circuit by accessing it from the classical and/or semi-conductor-based memory.

In an example embodiment, the quantum computer 30 (e.g., controller 38) is configured to determine the quantum circuit based at least in part on system information including the selected state of the logical qubit, the logical qubit state space, the initial state of the detector qubit, the detector qubit state space, the coupling strength J, and/or the like. For example, the quantum computer 30 (e.g., controller 38) may obtain the quantum circuit by generating the quantum circuit based at least in part on the system information. In an example embodiment, the quantum computer 30 (e.g., controller 38) is configured to determine the quantum circuit based at least in part on the system information and store the quantum circuit to the classical and/or semiconductor-based memory of the controller 38 such that the quantum computer 30 (e.g., controller 38) may obtain the quantum circuit by accessing the quantum circuit from the classical and/or semiconductor-based memory of the controller 38.

Continuing with FIG. 7, steps 704, 706, and 708 are iterated one or more times (e.g., N times). At step 704, the controller 38 causes the qubit manipulation system 36 to initialize one or more detector qubits into the initial state |0>. In various embodiments, the process of initializing the one or more detector qubits into the initial state |0> will be specific to the particular quantum computer 30 being used.

At step 706, the controller 38 causes the qubit manipulation system 36 to perform the steering circuit. For example, the qubit manipulation system 36 performs a sequence of interactions (e.g., quantum gates) between detector qubits and system qubits of the n system qubits that form the logical qubit via performance of the steering circuit. For example, a logical qubit is built from a plurality of system qubits. One or more of the system qubits of the plurality of system qubits are each entangled with one or more detector qubits via performance of the steering circuit. A single instance of the steering qubit addresses each of the n system qubits that form the logical qubit, in an example embodiment.

At step 708, the qubit measurement system 32 performs a respective measurement of each of the detector qubits. For example, the qubit measurement system 32 may interact with each of the detector qubits such that respective waveforms of the detector qubits are caused to collapse into respective single states. Because of the entanglement of the detector qubits with the system qubits that form the logical qubit, the collapse of the waveform of the respective detector qubit affects the quantum state of the respective system qubit. This effect steers the quantum state of the respective system qubit toward the selected state of the logical qubit (e.g., a selected state within the logical qubit state space).

At step 710, the quantum computer 30 (e.g., controller 38) determines whether the state of the logical qubit has converged to the selected state of the logical qubit (e.g., a selected state within the logical qubit state space). In various embodiments, various tests may be used to determine whether or not the state of the logical qubit has converged to the selected state of the logical qubit.

In an example embodiment, the quantum computer 30 (e.g., controller 38) determines that the collective state of the n system qubits has converged to the selected state of the logical qubit (e.g., a selected state within the logical qubit state space) when the steering process 310 (e.g., steps 704, 706, and 708) have been performed N times. For example, responsive to determining that the steering process 310 (e.g., steps 704, 706, and 708) have been performed less than N times, the quantum computer 30 (e.g., controller 38) determines that the collective states of the n system qubits has not converged to the selected state of the logical qubit (e.g., a selected state within the logical qubit state space) and the steering process 310 is performed again. For example, responsive to determining that the steering process 310 (e.g., steps 704, 706, and 708) have been performed N times or more, the quantum computer 30 (e.g., controller 38) determines that the collective state of the n system qubits has converged to the selected state of the logical system qubit (e.g., a selected state within the logical qubit state space).

Once the logical qubit is prepared and/or initialized into the selected state |ψ_{⊕} [symbol] , the quantum computer (e.g., the controller 38) may perform a quantum program using the logical qubit. For example, the controller 38 may control the qubit manipulation system 36 to cause performance of a sequence of quantum operations on one or more logical qubits of the quantum computer (each comprising a respective plurality of system qubits) to perform a quantum program. The qubit measurement system 32 may determine the quantum state of one or more of the system qubits and/or logical qubits such that a result of performing the quantum program may be determined and interpreted (e.g., by the controller 38 and/or the classical computing entity 10).

### Technical Advantages

Conventional techniques for performing the initializing and/or state preparation of logical qubits requires performance of many quantum gates and many measurements, resulting in a large amount of space and time overhead for initializing and/or performing state preparation of a logical qubit with sufficient fidelity. For example, an initializing routine may be formed, one or more syndromes of the logical qubit may be measured to determine whether the initialization was successful. In the frequent situations where the initialization was not successful, the initialization routine is performed repeatedly until the initialization is completed successfully. Therefore, technical problems exist regarding initialization and/or state preparation of logical qubits.

Various embodiments provide technical solutions to these technical problems. In particular, various embodiments employ quantum steering to prepare a surface code encoded logical qubit in a selected state with high fidelity. For example, in certain embodiments, the selected state is a ground state of the logical qubit and the logical qubit comprises a plurality of system qubits of the plurality of physical qubits that are organized as a surface error correcting code. In general, a surface error correcting code is a type of quantum error correction code that utilizes a two-dimensional lattice of qubits (as shown in FIG. 2) to encode logical information, allowing for the detection and correction of errors by measuring the parity of neighboring qubits and/or the expectation values of Aᵥ and Bₚ, where Aᵥ enacts the Pauli-Z rotation on each qubit around a vertex v, and Bₚ enacts the Pauli-X rotation on each qubit that makes up a plaquette p.

Quantum steering is a phenomenon in quantum mechanics whereby measurements on one system influences the state of another entangled system. In various embodiments, detector qubits are initialized into an initial state and then entangled with one or more system qubits of a logical qubit via a steering circuit. The detector qubits are then measured to cause the respective quantum wave functions of the detector qubits to collapse to respective single states. The steering circuit is configured to steer the system qubits of the logical qubit to either a respective selected state of the individual system qubits or to a selected state of the logical qubit. When the steering circuit is configured to steer the system qubits of the logical qubit into the respective selected state of the individual system qubits, a sequence of entangling gates is used to entangle the system qubits of the logical qubit into the selected state of the logical qubit. In various embodiments, multiple logical qubits may be prepared into the selected state and/or initialized at the same time.

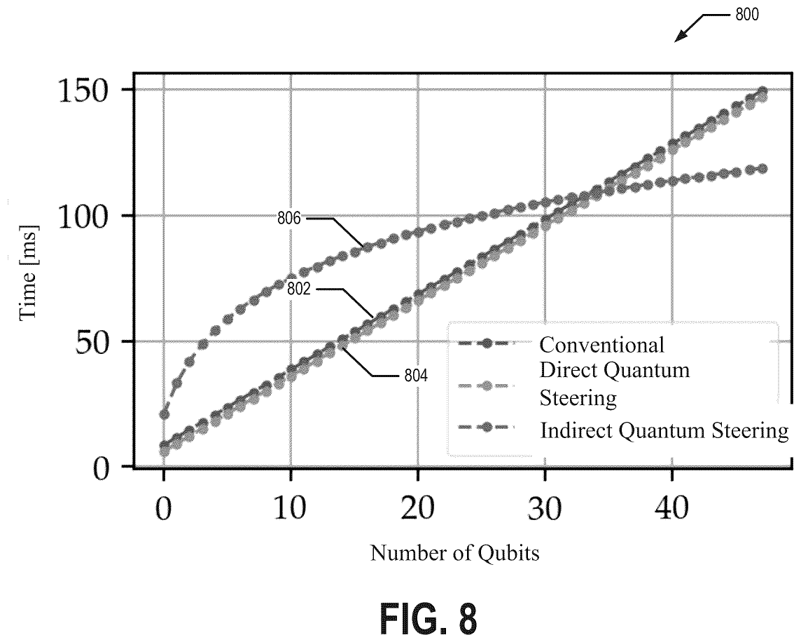

FIG. 8 provides a plot 800 that illustrates the amount of time in milliseconds required to perform a conventional logical qubit state preparation with respect to the number of qubits n of the logical qubit as line 802, the amount of time required to perform a direct quantum steering state preparation with respect to the number of qubits n of the logical qubit as line 804, and the amount of time required to perform an indirect quantum steering state preparation with respect to the number of qubits n of the logical qubit as line 806. As can be seen from plot 800, performance of a direct quantum steering state preparation require less time than performance of a conventional logical qubit state preparation. Moreover, for logical qubits having a large number of system qubits (e.g., n>32 or so), the indirect quantum steering state preparation takes substantially less time to perform than the conventional logical qubit state preparation. Thus, by steering the system qubits of the logical qubit toward the respective selected state of the individual system qubits or to a selected state of the logical qubit, the logical qubit can be prepared into the selected state efficiently (e.g., with reduced space and/or time overhead) and with high fidelity. Therefore, various embodiments provide improvements to the fields of quantum computing, fault tolerant quantum computing, and logical qubit state preparation and/or initialization.

### Exemplary Classical Computing Entity

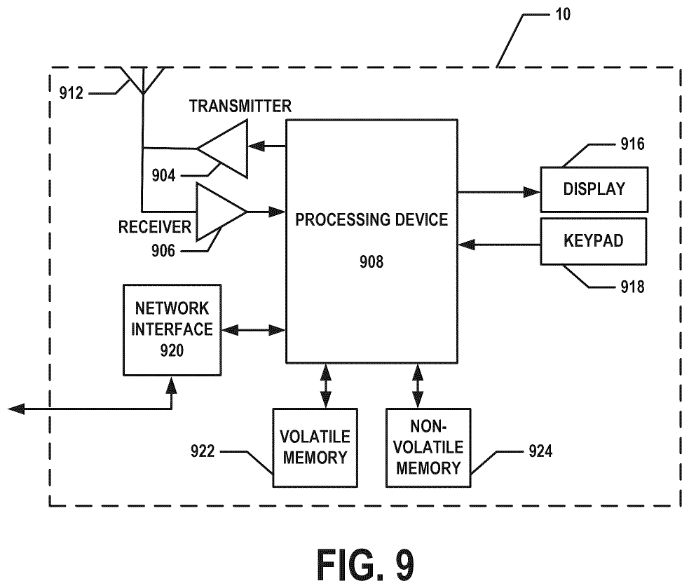

FIG. 9 provides an illustrative schematic representative of an example classical computing entity 10 that can be used in conjunction with embodiments of the present disclosure. As used herein, the term “classical” refers to semiconductor-based computing (e.g., semiconductor-based processing elements, semiconductor-based memory, and/or the like). In various embodiments, a classical computing entity 10 is configured to interface with a quantum computer 30. In various embodiments, the classical computing entity 10 is configured to interface with a quantum computer 30 so as to provide a steering circuit and/or other quantum circuits to the quantum computer 30 for performance and/or storage thereof, enable the classical computing entity 10 to receive qubit measurements, and/or the like. For example, the classical computing entity 10 may be configured to communicate with the quantum computer 30 to allow a user (e.g., a human user or a program operating on the classical computing entity 10) to receive, display, analyze, and/or the like output from the quantum computer 30.

As shown in FIG. 9, a classical computing entity 10 can include an antenna 912, a transmitter 904 (e.g., radio), a receiver 906 (e.g., radio), and a processing device 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a quantum computer 30, other classical computing devices, and/or the like. In this regard, the classical computing entity 10 may be capable of operating with one or more air interface standards, communication protocols, modulation types, and access types.

For example, the classical computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the classical computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The classical computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the classical computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The classical computing entity 10 can also download changes, add-ons, and updates, for instance, to its firmware, software (e.g., including executable instructions, applications, program modules), and operating system.

In various embodiments, the classical computing entity 10 may comprise a network interface 920 for interfacing and/or communicating with the quantum computer 30 and/or other classical computing devices, for example. In various embodiments, the classical computing entity 10 and the quantum computer 30 may communicate via a direct wired and/or wireless connection and/or via one or more wired and/or wireless networks 20.

In various embodiments, the processing device 908 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, graphics processing units (GPUs), central processing units (CPUs), other processing devices and/or circuitry, and/or the like. The term circuitry may refer to an entirely hardware embodiment or a combination of hardware and computer program products.

The classical computing entity 10 may also comprise a user interface device comprising one or more user input/output interfaces (e.g., a display 916 and/or speaker/speaker driver coupled to a processing device 908 and a touch screen, keyboard, mouse, and/or microphone coupled to a processing device 908). For instance, the user output interface may be configured to provide an application, browser, user interface, interface, dashboard, screen, webpage, page, and/or similar words used herein interchangeably executing on and/or accessible via the classical computing entity 10 to cause display or audible presentation of information/data and for interaction therewith via one or more user input interfaces. The user input interface can comprise any of a number of devices allowing the classical computing entity 10 to receive data, such as a keypad 918 (hard or soft), a touch display, mouse, voice/speech or motion interfaces, scanners, readers, or other input device. In embodiments including a keypad 918, the keypad 918 can include (or cause display of) the conventional numeric (0-9) and related keys (#, *), and other keys used for operating the classical computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the classical computing entity 10 can collect information/data, user interaction/input, and/or the like.

The classical computing entity 10 can also include (classical) volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the classical computing entity 10 (e.g., such as the distribution function discriminator).

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for preparing a logical qubit in a selected state, the method comprising:
obtaining, by a quantum computer, a steering circuit, wherein the steering circuit is a quantum circuit comprising one or more quantum interactions between at least one detector qubit and at least one system qubit that is performable by the quantum computer, wherein the quantum computer comprises a plurality of physical qubits that includes the at least one detector qubit and the at least one system qubit and the at least one system qubit is part of the logical qubit;
performing, by the quantum computer, one or more iterations of:
causing one or more detector qubits of the plurality of physical qubits to be initialized into an initial state,
causing performance of the steering circuit, and
causing measurement of the one or more detector qubits; and
determining, by the quantum computer, that the logical qubit is in the selected state.

2. The method of claim 1, further comprising:
responsive to determining respective states of one or more system qubits of the plurality of physical qubits have converged to respective intermediate states, causing application of a sequence of entangling gates to a plurality of system qubits of the plurality of physical qubits to cause the logical qubit to be in the selected state.

3. The method of claim 2, wherein the steering circuit is configured to enact a unitary operator Uₗ, wherein the unitary operator Uₗ is functionally representable as Euler's number e to the power of −iJH, where i is the square root of negative one, J is a coupling strength corresponding to the quantum computer, and H is a Hamiltonian for a system including one system qubit and one detector qubit of the plurality of physical qubits.

4. The method of claim 3, wherein the Hamiltonian is a vector product of a first operator that links the initial state to an orthogonal space of a detector state space and a second operator that links the selected state of the at least one system qubit to an orthogonal space of a system qubit state space and their Hermitian conjugates.

5. The method of claim 2, wherein entangling gates of the sequence of entangling gates are gates that are native to an architecture of the quantum computer and configured to entangle two or more qubits of the quantum computer, subject to local corrections using single qubit rotations of one or more of the two or more qubits.

6. The method of claim 2, wherein the respective states of the one or more system qubits of the plurality of physical qubits are determined to have converged to the respective intermediate states based on a determination that the one or more iterations were performed a selected number of times.

7. The method of claim 1, wherein the steering circuit is configured to enact a unitary operator Uₙ, wherein the unitary operator Uₙ is functionally representable as Euler's number e to the power of −iJH, where i is the square root of negative one, J is a tunable coupling strength that determines a convergence rate of the logical qubit being prepared into the selected state, and H is a Hamiltonian for a system including a plurality of system qubits and a plurality of detector qubits of the plurality of physical qubits.

8. The method of claim 7, wherein the Hamiltonian is an indexed sum of vector products of a first operator that links the initial state to an orthogonal space of a detector state space and a second operator that links the selected state of a state space of the plurality of system qubits to a respective state corresponding to an index of the indexed sum in an orthogonal space of a logical qubit state space and their Hermitian conjugates.

9. The method of claim 1, wherein the selected state is a ground state of the logical qubit.

10. The method of claim 1, wherein the logical qubit comprises a plurality of system qubits of the plurality of physical qubits that are organized as a surface error correcting code.

11. The method of claim 1, wherein the logical qubit is determined to be in the selected state responsive to determining that the one or more iterations were performed a selected number of times.

12. A quantum computer comprising:
a plurality of physical qubits;
a qubit measurement system;
a qubit manipulation system; and
a controller configured to control operation of the qubit manipulation system and receive input from the qubit measurement system,
wherein the controller is configured to at least:
obtain a steering circuit, wherein the steering circuit is a quantum circuit comprising one or more quantum interactions between at least one detector qubit and at least one system qubit that is performable by the quantum computer, wherein the plurality of physical qubits includes the at least one detector qubit and the at least one system qubit and the at least one system qubit is part of a logical qubit;
perform one or more iterations of:
causing the qubit manipulation system to initialize one or more detector qubits of the plurality of physical qubits into an initial state,
causing the qubit manipulation system to perform the steering circuit, and
causing the qubit measurement system to measure respective states of the one or more detector qubits; and
determine that the logical qubit is in a selected state.

13. The quantum computer of claim 12, wherein the controller is further configured to at least:
responsive to determining respective states of one or more system qubits of the plurality of physical qubits have converged to respective intermediate states, cause the qubit manipulation system to apply a sequence of entangling gates to a plurality of system qubits of the plurality of physical qubits to cause the logical qubit to be in the selected state.

14. The quantum computer of claim 13, wherein the steering circuit is configured to enact a unitary operator μₗ, wherein the unitary operator μₗ is functionally representable as Euler's number e to the power of −iJH, where i is the square root of negative one, J is a tunable coupling strength that determines a convergence rate of the logical qubit being prepared into the selected state, and H is a Hamiltonian for a system including one system qubit and one detector qubit of the plurality of physical qubits.

15. The quantum computer of claim 14, wherein the Hamiltonian is a vector product of a first operator that links the initial state to an orthogonal space of a detector state space and a second operator that links the selected state of the at least one system qubit to an orthogonal space of a system qubit state space and their Hermitian conjugates.

16. The quantum computer of claim 13, wherein entangling gates of the sequence of entangling gates are gates that are native to an architecture of the quantum computer and configured to entangle two or more qubits of the quantum computer, subject to local corrections using single qubit rotations of one or more of the two or more qubits.

17. The quantum computer of claim 12, wherein the steering circuit is configured to enact a unitary operator μₙ, wherein the unitary operator μₙ is functionally representable Euler's number e to the power of −iJH, where i is the square root of negative one, J is a tunable coupling strength that determines a convergence rate of the logical qubit being prepared into the selected state, and H is a Hamiltonian for a system including a plurality of system qubits and a plurality of detector qubits of the plurality of physical qubits.

18. The quantum computer of claim 17, wherein the Hamiltonian is an indexed sum of vector products of a first operator that links the initial state to an orthogonal space of a detector state space and a second operator that links the selected state of a state space of the plurality of system qubits to a respective state corresponding to an index of the indexed sum in an orthogonal space of a logical qubit state space and their Hermitian conjugates.

19. The quantum computer of claim 12, wherein the selected state is a ground state of the logical qubit and the logical qubit comprises a plurality of system qubits of the plurality of physical qubits that are organized as a surface error correcting code.

20. A computer program product comprising a non-transitory computer-readable medium storing executable instructions, the executable instructions configured to, when executed by a controller of a quantum computer, cause the quantum computer to:
obtain a steering circuit, wherein the steering circuit is a quantum circuit comprising one or more quantum interactions between at least one detector qubit and at least one system qubit that is performable by the quantum computer, wherein the quantum computer comprises a plurality of physical qubits that includes the at least one detector qubit and the at least one system qubit and the at least one system qubit is part of a logical qubit;
perform one or more iterations of:
causing a qubit manipulation system of the quantum computer to initialize one or more detector qubits of the plurality of physical qubits into an initial state,
causing the qubit manipulation system to perform the steering circuit, and
causing a qubit measurement system of the quantum computer to measure respective states of the one or more detector qubits; and
determine that the logical qubit is in a selected state.
